(19) United States
(12) Patent Application Publication
(10) Pub. No.: US 2006/0127611 A1
(43) Pub. Date: Jun. 15, 2006

(54) Architectural glass panel

(76) Inventor: Chip Hunter, Patchogue, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/010,722

(22) Filed: Dec. 13, 2004

(51) Int. Cl. E06B 3/24; B44F 1/06

(52) U.S. Cl. 428/34; 428/38

(57) ABSTRACT

A decorative glass safety panel is made of a stained glass pane and a base glass pane. The stained glass pane is made of individual stained glass pieces that are cut using waterjet technology and assembled together. An adhesive is used between the base glass pane and stained glass pane and bonds the two together. Further, a laminate may be applied to the stained glass pane, or a glass sheeting layer may be attached to the stained glass pane to protect the stained glass pane in more industrial applications. This results in an artistic architectural panel that is suitable for a multitude of applications in both commercial and residential environments.

### BACKGROUND OF THE INVENTION

1. Field of the Invention

The present invention relates to decorative glass products, and more specifically, to a multi-layered commercial glass panel where various stained glass pieces that are designed and cut using water jet technology are affixed to an inner layer of glass to form a decorative panel.

2. Prior Art

The prior art provides for laminated glasses that have been provided with color. To secure color into the glass, an oven-firing feature has usually been required, which is expensive and only achieves solid colors.

U.S. Pat. No. 5,049,433 provides for an architectural safety glass laminate having a glass sheet, a plastic substrate, and an adhesive film in between the glass sheet and plastic substrate bonding the two together. The decorative pattern can be applied to the plastic substrate by screen printing, which involves forcing ink through a stencil. The stencil is a screen having porous portions that allow passage of ink to flow through onto the substrate reproducing a desired image. A squeegee normally formed from a flexible material such as urethane is used to force the ink through the screen.

Screen printing originally was known as silk screen printing but over the years other supporting materials for the stencil image have replaced silk. Most commercial screen printing now is accomplished with stainless steel mesh that has openings much finer than those possible with silk or other textiles, and stencils now are formed by photographic processes.

There are three types of screen printing presses in use today: manual, semi-automatic, and automatic. All of them contain the basic elements of a stencil or screen, a squeegee, and some type of back-up plate or fixture to hold the substrate in place. Transfer means other than screen printing can be utilized, such as the techniques of letterpress, gravure (also called rotogravure), flexography, jet printing, pad transfer printing, and web printing. However, these processes all relate to the application of the decorative pattern onto a plastic substrate, and further, fail to provide precise accurate results on the plastic substrate that may be required by the artist.

Waterjet technology, on the other hand, is a computerized cold cutting technology that can cut most materials into any two dimensional shape. Waterjet cutting can best be described as a controlled accelerated erosion process. Marble, granite, porcelain, ceramic, linoleum, sports flooring, vinyl, and all metals are excellent materials for the waterjet process. Waterjet cutting is a clear cold process that does not heat, harden, or distort metals. Waterjet cleanly and efficiently cuts stone, ceramics, and porcelains.

The waterjet machine, instead of the diamond wheel, uses water to cut glass. This system consists of high pressure (up to 60,000 psi) water, mixed with abrasives, that passes through a gauge orifice at three times the speed of sound. Such pressure produces a pure working power able to cut any shape of glass or other materials. In comparison with the traditional diamond cutting system it has the following advantages: flexibility, high accuracy, works on any material, low cost, lack of heat generation.

Anything that can be drawn on a computer can be cut by waterjet. Many materials like stone, porcelain, and stainless steel cannot economically be cut into complex shapes in any other way.

A waterjet machine has essentially two components: the x-y-z table which moves the cutting head over the material and a high intensity pump that generates up to 60,000 psi. At this pressure, water alone can cut plastics, foam, wood, resilient floor coverings, rubber and similar soft substances. The cutting head can be a nozzle with a sapphire crystal orifice through which water is forced at three times the speed of sound by the high intensity pump. The movement of this nozzle is determined by computer instructions the machine follows. When cutting harder materials such as metals, stone, ceramics, glass and dense composites, a garnet abrasive is fed into the waterjet stream for stronger erosion action. The waterjet stream does not exert pressure or heat on the working material.

Waterjet is an important breakthrough in fabrication methods for both industrial and architectural applications. Depending on the material, thickness and intricacy of the cut, the savings compared to traditional cutting methods can be substantial. Waterjet cutting has significant advantages over competing cutting methods, such as routers, plasma torch, laser cutting and electrical discharge machining (EDM). Waterjet can be an alternative to casting forged blanks. Waterjet can cut through materials considered “unmachinable” by conventional cutting methods.

The advantages of this process extend beyond its cost-competitiveness with other cutting techniques. Waterjet allows for complex and difficult shapes, such as inside corners, notches, architectural and artistic shapes, to be cut with equal ease and with a high level of accuracy and precision. Because this is a CAD driven process it also offers the capability of repeatability, not available with most other cutting methods. Waterjet can be used for cutting composites and plastics that cannot tolerate heat, mechanical damage or delimitation. There are no molding or tooling costs associated with waterjet.

The CAD-CAM process and narrow kerf (or cut) resulting from the waterjet allows for exceptionally efficient usage of expensive materials such as titanium, composites and optical glass. The narrow kerf allows for optimum yield due to nesting (tight tolerances +/−0.010 inches depending on the material). In addition the process provides mass production capability with CAD/CAM repeatability. Parts can be manufactured by simply reentering previously run computer programs.

Thus, there is a need for a decorative multi-layered glass panel and method of producing a multi-layered glass panel that uses waterjet technology to cut precise and accurate decorative patterns on the glass panel(s) itself.

### SUMMARY OF THE INVENTION

Therefore, it is an object of the present invention to provide an architectural panel arranged with individual waterjet cut stained glass pieces attached to a base panel. Spaces between the individual pieces can be filled with a grout and an acrylic additive or some other filler as desired to create a finished artistic element for use in commercial and residential architectural embellishments.

Another object of the present invention is to provide a decorative safety panel by any combination of additions to the architectural panel such as: substituting a tempered glass panel for the base panel and then laminating the surface of the waterjet cut pieces, or adding a glass sheeting layer to the stained glass panel. Another object is to use the architectural panel in the center of an insulated glass unit with tempered clear glass set above and below the decorative architectural panel using spacers and then sealing the outside perimeter.

Accordingly, an architectural glass panel is provided comprising a base pane, one or more individual pieces cut using waterjet technology arranged on the base pane, and an adhesive that bonds the one or more individual pieces with the base pane.

The base pane can be a textured glass pane, which can be colored or tinted. The one or more individual pieces can be stained glass pieces and assembled on the base pane to form a stained glass pane. The one or more individual pieces can also be colored plastic pieces and assembled on the base pane to form a colored plastic pane. The spaces between the individual stained glass pieces can be filled with a grout and an acrylic additive.

The architectural glass panel further comprises a glass sheeting attached to the one or more individual pieces arranged on the base pane, and a double-sided adhesive that attaches the glass sheeting to the one or more individual pieces along an outer perimeter of the glass sheeting. The architectural glass panel further comprises a liquid laminate injected between the glass sheeting and one or more individual pieces, allowing completion of a laminate bond between the glass sheeting and one or more individual pieces, wherein the double-sided adhesive seals the laminate along the edges of the glass sheeting. The double-sided adhesive can be a double-sided adhesive tape.

The architectural glass panel further comprises a laminate glaze applied to the one or more individual pieces and/or to the base panel to provide a safety architectural panel.

Also provided is a method of making an architectural glass panel, the method comprising the steps of cutting one or more individual pieces using waterjet technology, assembling the one or more individual pieces to form a top pane, and attaching the top pane to a base pane by using an adhesive between the top pane and the base pane. The method further comprises filling the spaces between the one or more individual pieces with a grout and an acrylic additive.

The method can further comprise attaching a glass sheeting on top of the one or more individual pieces forming the top pane, using a double-sided adhesive to attach the glass sheeting to the one or more individual pieces forming the top pane, and placing the double-sided adhesive along the perimeter of the top pane and glass sheeting to provide a safety panel. The method further comprises injecting a liquid laminate between the glass sheeting and top pane, allowing completion of a laminate bond between the glass sheeting and top pane, wherein the double-sided adhesive seals the laminate along the edges of the top pane and glass sheeting.

Alternatively, the method can further comprise applying a laminate glaze to the top pane and/or base pane to provide a safety panel.

Also provided is an insulated glass unit, comprising a first layer of clear tempered glass, a second layer of clear tempered glass, and one or more individual glass pieces cut using waterjet technology and assembled on an inner layer of glass to form a stained glass pane, wherein the stained glass pane is placed between the first layer of clear tempered glass and the second layer of clear tempered glass. A first spacer is provided between the first layer of clear tempered glass and the stained glass panel, and a second spacer is provided between the second layer of clear tempered glass and the stained glass panel.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 is a perspective view of a decorative glass panel in accordance with the present invention.

FIG. 2 is a front view of another decorative glass panel in accordance with the present invention.

FIG. 3 is a side view of a decorative glass panel as provided in FIG. 1 with the addition of a strong laminated bond to create safety glass.

FIG. 4 is an exploded view of the present invention as used in an IG unit.

### DETAILED DESCRIPTION OF THE PREFERRED EMBODIMENT

Although this invention may be applicable to various decorative panels constructed of different materials, it has been found particularly useful in the environment of decorative glass panels using water jet technology. Therefore, without limiting the applicability of the invention to the above, the invention will be described in such environment.

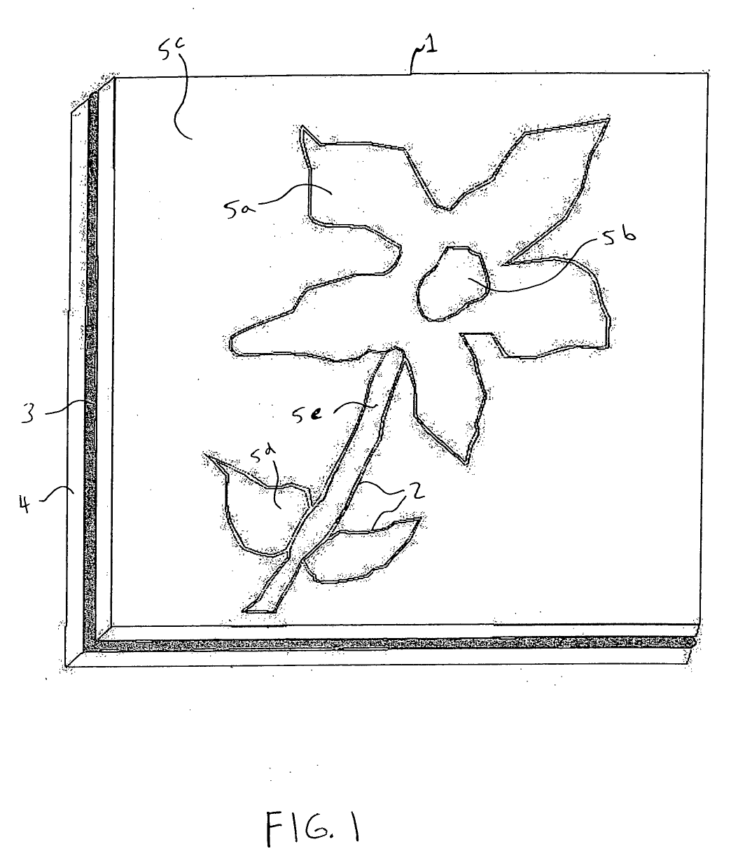

With reference now to the drawings, the components of the present invention will be described. FIG. 1 shows an architectural panel in accordance with the present invention after the cutting and assembly process but before the lamination process. A stained glass pane 1 is comprised of individual stained glass pieces 5a, 5b, 5c, 5d and 5e. First, these individual stained glass pieces 5a-5e are individually cut with a waterjet machine. The individual stained glass pieces 5a-5e can form any kind of artistic design, such as a flower as shown in FIG. 1. Each individual piece of the individual stained glass pieces 5a-5e can be of the same or of a different color, depending on the artist's choice. Using waterjet technology, the individual stained glass pieces 5a-5e are precisely and accurately cut. The pieces 5a, 5b, 5c and 5d can be cut so they are contained within a border created by the piece 5c, thus allowing various designs to be formed for the architectural panel.

The stained glass pieces 5a-5e are then arranged and assembled by bonding the stained glass pieces 5a-5e to a base glass pane 4 that is used as a base layer. The stained glass pieces 5a-5e are bonded to the base glass pane 4 using a clear adhesive 3. Any adhesive known in the art used to bond panes or layers may be used for the clear adhesive 3. The base glass pane 4 may be plain or textured, and also may be clear or tinted. Different designs can be made on the base glass pane 4 so that they are visible through the waterjet cut designs of the individual stained glass pieces 5a-5e. This gives the architectural glass panel an artistic visual effect that is not achieved by glass panels in the prior art.

Once the individual stained glass pieces 5a-5e are assembled together and bonded to the base glass pane 4, there may be spaces 2 showing after the individual stained glass pieces 5a-5e are bonded. Then, the spaces 2 between the individual stained glass pieces 5a-5e can be filled with a filler such as a grout with an acrylic additive. A standard tile grout may be used as the grout. Any type of filler may be used. If extremely accurate technology is used, there may be no spaces 2 and a filler may not be necessary.

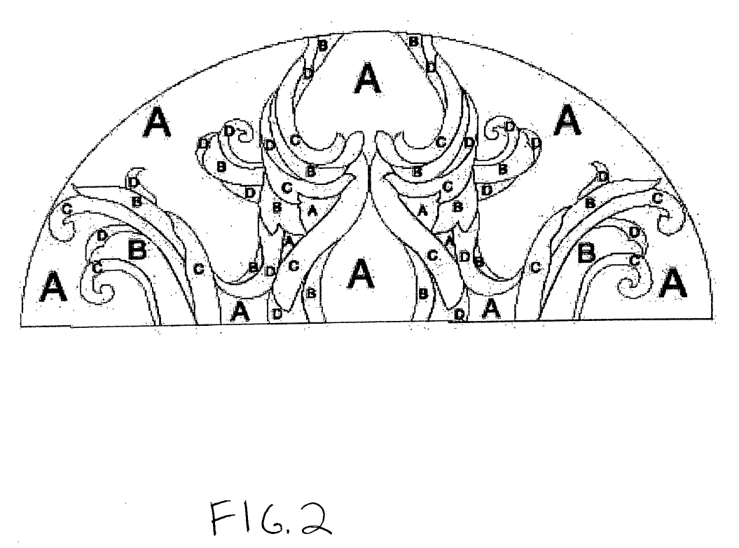

FIG. 2 is a front view of another type of decorative glass panel in accordance with the present invention. Here, individual stained glass pieces A, B, C and D are cut using waterjet technology. Each piece may be of the same or different color of glass. For example, all pieces labeled A can be of one color, all the pieces labeled B can be of a different color, etc. Here, all the pieces A-D are separately cut using waterjet technology into individual pieces. Once they are assembled as shown in FIG. 2, they can represent any type of design, such as a semicircle as shown. These pieces are assembled and attached to a base glass pane as described above for FIG. 1, and a filler may be used to fill in spaces, if any, between the individual stained glass pieces A-D.

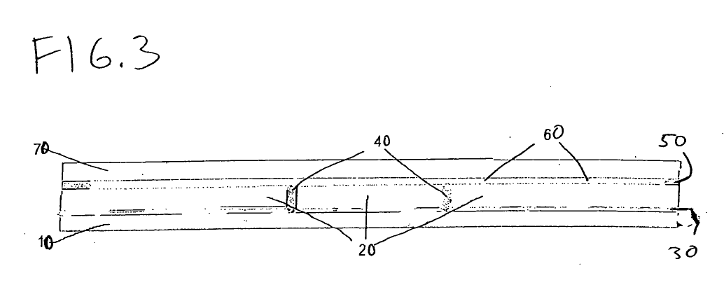

FIG. 3 represents a side view of the final stage of the architectural panel in the process, only if it requires enhancement as a safety glass. Similar to FIG. 1, individual stained glass pieces are cut using waterjet technology and arranged and assembled to form a stained glass pane 20, by adhering the glass pieces to a base glass pane 10 using a clear adhesive 30. The base glass pane 10 may be solid or textured, and clear or tinted. The stained glass pane 20 is comprised of stained glass pieces that are cut with a waterjet machine and assembled. A grout with an acrylic additive can be used to fill spaces 40 between the stained glass pieces forming the stained glass pane 20.

One of two methods can be used to enhance the architectural panel into a safety panel. In one method, if the base panel 10 is tempered, then a laminate glaze, such as DecoThane Clear®, can be applied to the stained glass pane 20. This laminate can also be applied to the base glass pane 10 if the base glass pane 10 is not tempered. This laminate ensures that the individual stained glass pieces forming the stained glass pane 20 and/or the base glass pane will withstand stress and pressure to a certain extent, and thus the architectural panel is now enhanced as a safety panel. For example, the laminate can be applied to the stained glass pieces 5a-5e and/or base pane 4 as seen in FIG. 1 to enhance the architectural panel into a safety glass panel.

In a second method, as shown in FIG. 3, a glass sheeting 70 is attached to the top of the stained glass pane 20. The glass sheeting is preferably ⅛ inch clear glass sheeting. Double-sided adhesive 50 is used to attach the glass sheeting 70 to the stained glass pane 20. The double-sided adhesive is only used on the perimeter of the edges of the stained glass pane 20 and glass sheeting 70, so that a closed environment is created between the stained glass pane 20 and glass sheeting 70. Then, a liquid pour laminate is injected through one or more tiny holes 60 left on the adhesive 50, so that the laminate fills the space between the stained glass pane 20 and glass sheeting 70. This allows the laminate to get into all the cracks and crevices of the stained glass pane 20 creating a solid bond. The double-sided adhesive 50 seals the liquid pour along the edges and perimeter of the stained glass pane 20 and glass sheeting 70 so that the liquid pour does not leak out. This allow completion of a laminate bond between the glass sheeting 70 and stained glass pane 20 that meets industry safety standards.

The panel of FIGS. 1 and 2 allows for wall hangings and decoration pieces suitable for indoor use. The panel of FIG. 3 allows for more commercial industrial applications, such as use for walls or more heavy type of applications suitable for outdoor use requiring safety glass standards, where the stained glass pane will have to be protected.

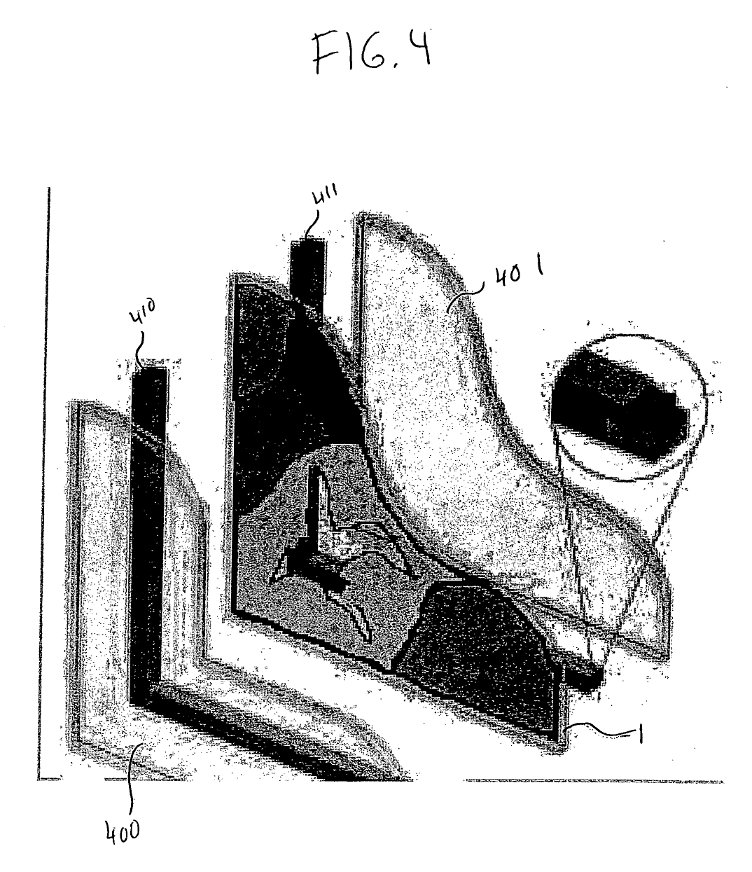

FIG. 4 shows an example of the present invention used in an IG unit. A stained glass pane 1 (comprised of stained glass pieces cut using waterjet technology and assembled on a layer of glass, as described above) is placed between a first layer of clear tempered glass 400 and a second layer of clear tempered glass 401. Spacers 410 and 411 are provided between the first layer of clear tempered glass 400 and the stained glass pane 1, and between the second layer of clear tempered glass 401 and the stained glass pane 1. The space created by the spacers 410 and 411 by holding the stained glass pane 1 between the two layers of tempered glass creates an insulating air space. Once the spacers 410 and 411 are attached to the outer perimeter of the stained glass pane 1, and the tempered glass layers 400 and 401 are in place, a sealant is applied to the outer edges. This provides for an insulated multi layer product that can be used in doors, windows and other applications requiring the benefits of IG units.

An optimum energy balance with less heating loss and additional sound insulation is among some of the benefits associated with IG units. Insulating glass units improve the thermal performance of glazing by providing a thermal break—two layers of glass separated by a sealed air space. These key properties enable insulating glass to meet two very different requirements—keeping heat in during winter and keeping heat out during the summer. IG units provide several benefits, such as savings on heating and cooling by reducing air-to-air heat transfer, increasing personal comfort and aiding in energy conservation, retarding sound transmission, and increasing strength to withstand wind loads.

The present invention provides several advantages over the prior art panels. It provides a glass panel with stained glass pieces that are cut using waterjet technology that results in the stained glass pieces being accurately and precisely cut, giving an authentic visual effect to the stained glass pieces that is not available by the methods used in the prior art. Further, attaching the stained glass panes with the base glass pane gives an artistic visual effect to the architectural panel as the base glass pane may be textured and colored or tinted. The design and color of the base glass pane is thus visible when viewing the stained glass pane, giving an artistic effect not available in the prior art glass panels. Lastly, attaching a glass sheeting to the stained glass pane protects the stained glass pane and yet allows a viewer to see the base glass pane and stained glass pane, allowing the architectural panel to have more commercial applications.

The above description of the present invention is only the preferred embodiments of the invention. Various other combinations of architectural panels are possible, where the stained pane comprised of individual stained pieces cut using waterjet technology may not be of glass but of a plastic, mirror or a metal. Further, the base pane may not be glass, but made of a plastic, paper, mirror, wood or metal as well. Any type of adhesive can be used that attaches the stained glass pane to the base pane as seen in FIG. 1.

To enhance the architectural panel into a safety panel, the base pane may be tempered or a laminate may be provided on the base pane. The top pane may be laminated, or a glass sheeting may be attached to the stained pane. Any combination of the stained pane and bottom pane may be used. Any adhesive may be used as the double-sided adhesive that attaches the stained glass pane with the glass sheeting, such as but not limited to double-sided tape, and any laminate may be used as the laminate that attaches the stained glass pane with the glass sheeting of FIG. 3.

There are several other uses of the invention not limited by the preferred description and embodiment as described above. The invention has applicability in many residential as well as commercial applications. For example, the architectural glass panel may be hung in windows with art scenes or may be window hangings. The architectural glass panel may be small such a's for a window or wall, or may be used as the window itself in a larger sense, such as windows for a building or church.

The above combination of artistry, waterjet technology and the safety enhancement of the architectural glass panel allows for a unique product that offers the public a panel not available in the prior art.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An architectural panel, comprising:
a base pane;
one or more individual pieces cut using waterjet technology arranged on said base pane; and
an adhesive that bonds the one or more individual pieces with the base pane.

2. The architectural panel of claim 1, wherein the base pane is a textured glass pane.

3. The architectural panel of claim 2, wherein the textured base glass pane is colored.

4. The architectural panel of claim 2, wherein the textured base glass pane is tinted.

5. The architectural panel of claim 1, wherein the one or more individual pieces are stained glass pieces and assembled on said base pane to form a stained glass pane.

6. The architectural panel of claim 1, wherein the one or more individual pieces are colored plastic pieces and assembled on said base pane to form a colored plastic pane.

7. The architectural panel of claim 1, wherein spaces between the one or more individual pieces are filled with a grout and an acrylic additive.

8. The architectural panel of claim 1, further comprising:
a glass sheeting attached to the one or more individual pieces arranged on said base pane; and
a double-sided adhesive that attaches the glass sheeting to the one or more individual pieces along an outer perimeter of the glass sheeting.

9. The architectural panel of claim 8, further comprising:
a liquid laminate injected between the glass sheeting and one or more individual pieces, allowing completion of a laminate bond between the glass sheeting and one or more individual pieces;
wherein the double-sided adhesive seals the laminate along the edges of the glass sheeting.

10. The architectural panel of claim 8, wherein the double-sided adhesive is double-sided adhesive tape.

11. The architectural panel of claim 1, further comprising:
a laminate glaze applied to the one or more individual pieces to provide a safety panel.

12. The architectural panel of claim 1, further comprising:
a laminate glaze applied to the base pane to provide a safety panel.

13. A method of making an architectural panel, comprising the steps of:
cutting one or more individual pieces using waterjet technology;
assembling the one or more individual pieces to form a top pane; and
attaching the top pane to a base pane by using an adhesive between the top pane and the base pane.

14. The method of making an architectural panel of claim 13, further comprising:
filling the spaces between the one or more individual pieces with a grout and an acrylic additive.

15. The method of making an architectural panel of claim 13, further comprising:
using a textured glass pane as the base pane.

16. The method of making an architectural panel of claim 15, further comprising:
using a colored glass pane as the textured glass pane.

17. The method of making an architectural panel of claim 15, further comprising:
using a tinted glass pane as the textured glass pane.

18. The method of making an architectural panel of claim 13, further comprising:
attaching a glass sheeting on top of the one or more individual pieces forming the top pane.

19. The method of making an architectural panel of claim 18, further comprising:
using a double-sided adhesive to attach the glass sheeting to the one or more individual pieces forming the top pane; and
placing the double-sided adhesive along the perimeter of the top pane and glass sheeting.

20. The method of making an architectural panel of claim 19, further comprising:
injecting a liquid laminate between the glass sheeting and top pane, allowing completion of a laminate bond between the glass sheeting and top pane;
wherein the double-sided adhesive seals the laminate along the edges of the top pane and glass sheeting.

21. The method of making an architectural panel of claim 13, further comprising:
using stained glass as the one or more individual pieces.

22. The method of making an architectural panel of claim 13, further comprising:
using plastic pieces as the one or more individual pieces.

23. The method of making an architectural panel of claim 13, further comprising:
applying a laminate glaze to the top pane to provide a safety panel.

24. The method of making an architectural panel of claim 13, further comprising:
applying a laminate glaze applied to the base pane to provide a safety panel.

25. An insulated glass unit, comprising:
a first layer of clear tempered glass;
a second layer of clear tempered glass; and
one or more individual glass pieces cut using waterjet technology and assembled on an inner layer of glass to form a stained glass pane;
wherein the stained glass pane is placed between said first layer of clear tempered glass and said second layer of clear tempered glass.

26. The insulated glass unit of claim 25, further comprising:
a first spacer provided between said first layer of clear tempered glass and said stained glass panel; and
a second spacer provided between said second layer of clear tempered glass and said stained glass panel.
